(19) United States
(12) Patent Application Publication
(10) Pub. No.: US 2015/0306821 A1
(43) Pub. Date: Oct. 29, 2015

(54) METHOD OF MANUFACTURING THREE-DIMENSIONAL STRUCTURE AND THREE-DIMENSIONAL STRUCTURE

(71) Applicant: SEIKO EPSON CORPORATION, Tokyo (JP)

(72) Inventors: Koki HIRATA, Matsumoto (JP); Shinichi KATO, Matsumoto (JP); Hiroshi FUKUMOTO, Shiojiri (JP); Chigusa SATO, Shiojiri (JP)

(21) Appl. No.: 14/692,980

(22) Filed: Apr. 22, 2015

(30) Foreign Application Priority Data
Apr. 23, 2014 (JP) 2014-089575

(51) Int. Cl. B29C 67/00

(52) U.S. Cl. CPC B29C 67/0081; B29L 2031/772

(57) ABSTRACT

Provided is a method of manufacturing a three-dimensional structure, in which the three-dimensional structure is manufactured by laminating a layer, the method including: forming the layer using a three-dimensional formation composition containing a surface-hydrophilic particle and a binding resin having a hydroxyl group; and discharging a curable ink containing a ultraviolet curable resin having an isocyanate group to the layer, in which an urethane group is formed by the hydroxyl group of the binding resin and the isocyanate group of the ultraviolet curable resin.

### BACKGROUND

1. Technical Field

The present invention relates to a method of manufacturing a three-dimensional structure, and a three-dimensional structure.

2. Related Art

A technology of forming a three-dimensional object while hardening powder with a binding solution is known (for example, refer to JP-A-6-218712). In this technology, a three-dimensional object is formed by repeating the following operations. First, powder is thinly spread in a uniform thickness to form a powder layer, and a binding solution is discharged to a desired portion of the powder layer to bind the powder particles together. As a result, in the powder layer, only the portion to which the binding solution is discharged is attached to form a thin plate-like member (hereinafter referred to as “section member”). Thereafter, a thin powder layer is further formed on this powder layer, and a binding solution (curable ink) is discharged to a desired portion thereof. As a result, a new section member is formed even on the portion of the newly-formed powder layer to which the binding solution is discharged. In this case, since the binding solution discharged on the powder layer penetrates the powder layer to reach the previously-formed section member, the newly-formed section member is attached to the previously-formed section member. The thin plate-like section member is laminated one by one by repeating these operations, thus forming a three-dimensional object.

In this technology of forming a three-dimensional object, when three-dimensional shape data of an object to be formed exists, it is possible to directly form a three-dimensional object by binding powder, and it is possible to quickly and inexpensively form a three-dimensional object because there is no need to create a mold prior to forming. In addition, since the three-dimensional object is formed by laminating the thin plate-like section member one by one, for example, even in the case of a complex object having an internal structure, it is possible to form the three-dimensional object as an integrally-formed structure without dividing the complex object into a plurality of parts.

However, in the related art, a binding solution cannot exhibit sufficiently high binding force, and thus the strength of a three-dimensional structure could not be made sufficiently high.

### SUMMARY

An advantage of some aspects of the invention is to provide a method of manufacturing a three-dimensional structure, by which a three-dimensional structure having excellent mechanical strength can be efficiently manufactured, and to provide a three-dimensional structure having excellent mechanical strength.

The invention is realized in the following forms.

According to an aspect of the invention, there is provided a method of manufacturing a three-dimensional structure, in which the three-dimensional structure is manufactured by laminating a layer, the method including: forming the layer using a three-dimensional formation composition containing a surface-hydrophilic particle and a binding resin having a hydroxyl group; and discharging a curable ink containing an ultraviolet curable resin having an isocyanate group to the layer.

In this case, it is possible to provide a method of manufacturing a three-dimensional structure, by which a three-dimensional structure having excellent mechanical strength can be efficiently manufactured.

In the method of manufacturing a three-dimensional structure according to the aspect of the invention, it is preferable that the method includes heating the layer after discharging the curable ink.

In this case, it is possible to further improve the mechanical strength of a three-dimensional structure to be finally obtained.

In the method of manufacturing a three-dimensional structure according to the aspect of the invention, it is preferable that the heating temperature in the heating of the layer is 40° C. to 100° C.

In this case, it is possible to further efficiently improve the mechanical strength of a three-dimensional structure to be finally obtained.

In the method of manufacturing a three-dimensional structure according to the aspect of the invention, it is preferable that the particle has a hydroxyl group on a surface thereof.

In this case, it is possible to particularly increase the affinity between the binding resin and the particle.

In the method of manufacturing a three-dimensional structure according to the aspect of the invention, it is preferable that the particle is made of silica.

In this case, it is possible to particularly increase the mechanical strength of a three-dimensional structure to be finally obtained.

In the method of manufacturing a three-dimensional structure according to the aspect of the invention, it is preferable that the binding resin is at least one selected from the group consisting of polyethylene glycol, polyethylene oxide, polyvinyl alcohol, carboxymethyl cellulose, and hydroxyethyl cellulose.

In this case, it is possible to particularly increase the affinity between the binding resin and the particle.

According to another aspect of the invention, there is provided a three-dimensional structure, which is manufactured by the method of manufacturing a three-dimensional structure.

In this case, it is possible to provide a three-dimensional structure having excellent mechanical strength.

### BRIEF DESCRIPTION OF THE DRAWINGS

The invention will be described with reference to the accompanying drawings, wherein like numbers reference like elements.

FIGS. 1A to 1D are schematic views showing each process of a preferred embodiment in the method of manufacturing a three-dimensional structure of the invention.

FIGS. 2A to 2D are schematic views showing each process of a preferred embodiment in the method of manufacturing a three-dimensional structure of the invention.

FIG. 3 is a cross-sectional view schematically showing the state of a particle and a binding resin.

FIG. 4 is a perspective view showing a shape of a three-dimensional structure (three-dimensional structure A) manufactured in each of Examples and Comparative Examples.

FIG. 5 is a perspective view showing the shape of a three-dimensional structure (three-dimensional structure B) manufactured in each of Examples and Comparative Examples.

### DESCRIPTION OF EXEMPLARY EMBODIMENTS

Hereinafter, preferred embodiments of the invention will be described in detail with reference to the accompanying drawings.

### 1. Method of Manufacturing Three-Dimensional Structure

First, the method of manufacturing a three-dimensional structure according to the invention will be described.

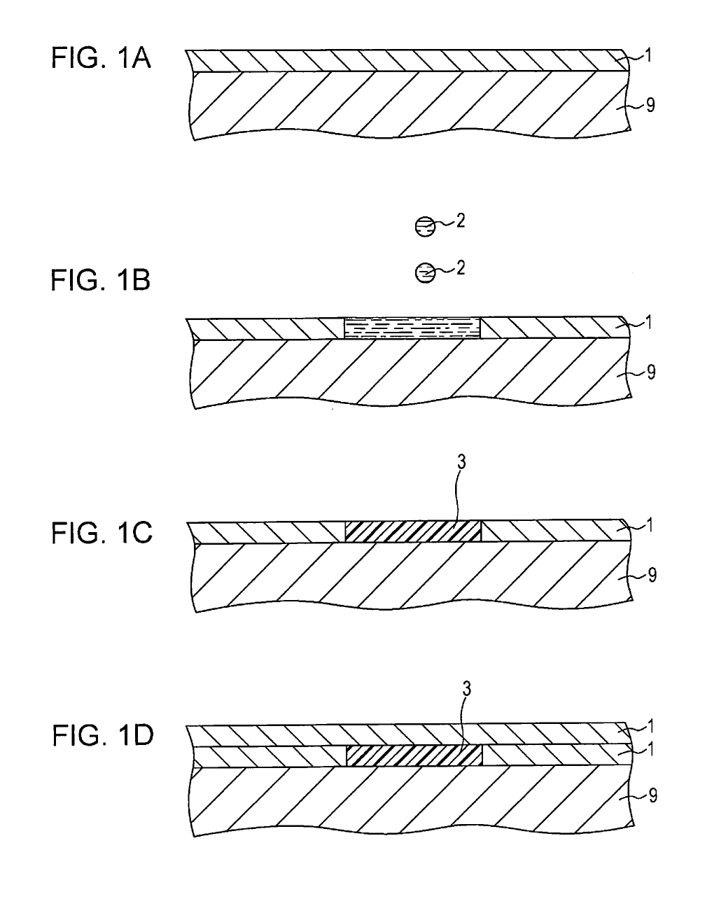

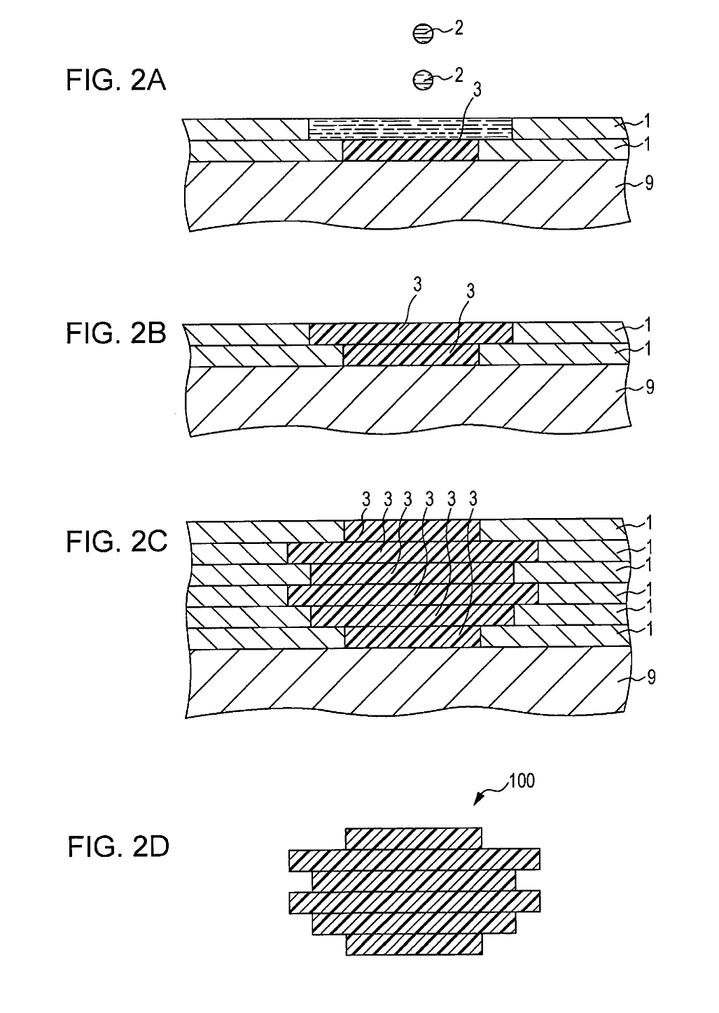

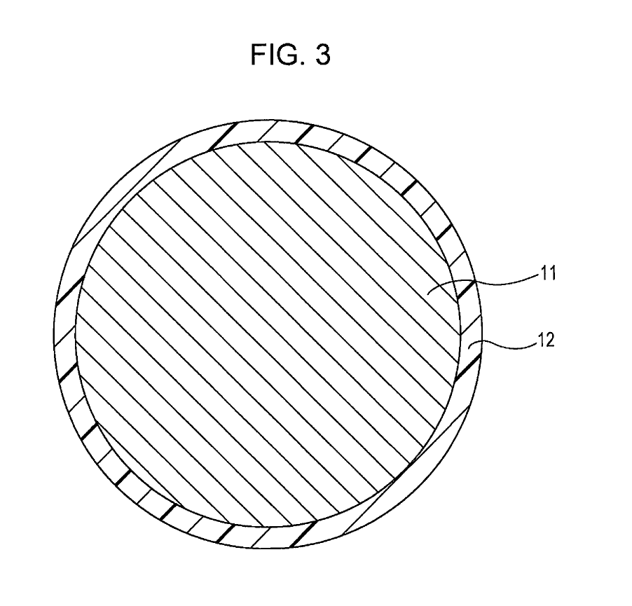

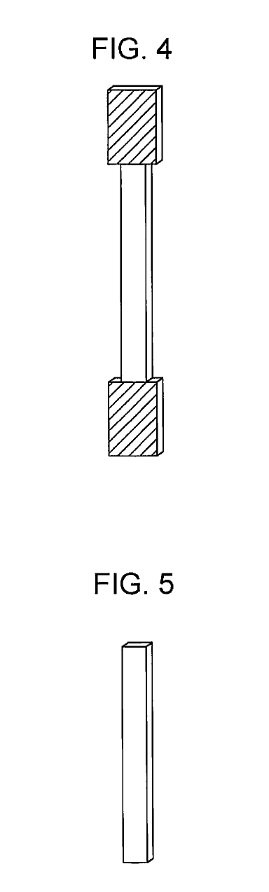

FIGS. 1A to 2D are schematic views showing each process of a preferred embodiment in the method of manufacturing a three-dimensional structure of the invention. FIG. 3 is a cross-sectional view schematically showing the state of a particle and a binding resin.

As shown in FIGS. 1A to 2D, the method of manufacturing a three-dimensional structure according to the present embodiment includes: layer forming processes (1A and 1D) of forming layers 1 using a three-dimensional formation composition 1′; ink discharge processes (1B and 2A) of applying a curable ink 2 containing a ultraviolet curable resin to each of the layers 1 by an ink jet method; and curing processes (1C and 2B) of curing the ultraviolet curable resin 21 contained in the curable ink 2 applied to each of the layers 1. Here, these processes are sequentially repeated. The method of manufacturing a three-dimensional structure further includes an unbound particle removal process (2D) of removing particles, which are not bound by the ultraviolet curable resin 21, from the particles 11 constituting each of the layers 1.

### Layer Forming Process

First, a layer 1 is formed on a support (stage) 9 using a three dimension forming composition 1′ (1A).

The support 9 has a flat surface (site on which the three dimension forming composition 1′ is applied). Thus, it is possible to easily and reliably form a layer 1 having high thickness uniformity.

It is preferable that the support 9 is made of a high-strength material. Various kinds of metal materials, such as stainless steel and the like, are exemplified as the constituent material of the support 9.

In addition, the surface (site on which the three-dimensional formation composition 1′ is applied) of the support 9 may be surface-treated. Thus, it is possible to effectively prevent the constituent material of the three dimension forming composition 1′ or the constituent material of the curable ink 2 from adhering to the support 9, and it is also possible to realize the stable production of a three-dimensional structure 100 over a long period of time by making the durability of the support 9 particularly excellent. As the material used in the surface treatment of the support 9, a fluorine-based resin, such as polytetrafluoroethylene, is exemplified.

The three-dimensional formation composition 1′ contains a plurality of surface-hydrophilic particles 11 and a binding resin 12 having a hydroxyl group.

By allowing the three-dimensional formation composition 1′ to contain the binding resin 12, the particles 11 are bound (temporarily fixed) together to effectively prevent the involuntary scattering of the particles 11. Thus, it is possible to improve the safety of workers or the dimensional accuracy of the three-dimensional structure 100 manufactured.

Particularly, since the particles 11 have surface hydrophilicity, they have high affinity for the binding resin 12 having a hydroxyl group. Therefore, in the three-dimensional formation composition 1′, as shown in FIG. 3, the particle 11 is covered therearound with the binding resin 12. In addition, since the affinity of the particle 11 for the binding resin 12 is high, the adhesiveness between the particle 11 and the binding resin 12 becomes higher. The entire surface of the particle 11 may not be completely covered with the binding resin 12.

Particularly, when the particle 11 has a hydroxyl group on the surface thereof, a hydrogen bond occurs between the hydroxyl group of the binding resin 12 and the hydroxyl group of the surface of the particle 11, and thus the binding resin 12 more strongly adheres to the surface of the particle 11. As a result, it is possible to further increase the mechanical strength of the three-dimensional structure to be finally obtained.

This process can be performed using a squeegee method, a screen printing method, a doctor blade method, a spin coating method, or the like.

The thickness of the layer 1 formed in this process is not particularly limited, but is preferably 30 μm to 500 μm, and more preferably 70 μm to 150 μm. Thus, the productivity of the three-dimensional structure 100 can be sufficiently increased, the occurrence of involuntary unevenness in the manufactured three-dimensional structure 100 can be more effectively prevented, and the dimensional accuracy of the three-dimensional structure 100 can be particularly increased.

### Ink Discharge Process

Thereafter, a curable ink 2 containing an ultraviolet curable resin having an isocyanate group is discharged to the layer 1 by an ink jet method (1B).

In this process, the curable ink 2 is selectively applied only to the site corresponding to the real part (substantial site) of the three-dimensional structure 100 in the layer 1.

Thus, the particles 11 constituting the layer 1 can be strongly bound together by the ultraviolet curable resin, and therefore, the mechanical strength of the three-dimensional structure 100 to be finally obtained can be increased. More specifically, in the invention, a urethane bond is formed by the hydroxyl group of the binding resin 12 covering the particle 11 and the isocyanate group of the curable resin, and thus the particles 11 are bound together with each other through the binding resin 12 and the curable ink. As a result, the mechanical strength of the three-dimensional structure 100 to be finally obtained can be increased.

In this process, since the curable ink 2 is applied by an ink jet method, the curable ink 2 can be applied with good reproducibility even when the pattern of the applied curable ink 2 has a fine shape. As a result, together with the effect of the ultraviolet curable resin 21 permeating into the holes 111 of the particle 11, the dimensional accuracy of the three-dimensional structure 100 to be finally obtained can be particularly increased.

Meanwhile, the curable ink 2 will be described in detail later.

### Curing Process

Next, the layer 1 is irradiated with ultraviolet rays to cure the ultraviolet curable resin applied to the layer 1, thereby forming a cured portion 3 (1C). Thus, binding strength between the particles 11 can be made particularly excellent, and, as a result, the mechanical strength of the three-dimensional structure 100 to be finally obtained can be made particularly excellent.

The ink discharge process and the curing process may be simultaneously performed. That is, the curing reaction may sequentially proceed from the site on which the curable ink 2 is applied, before the entire pattern of the entire one layer 1 is formed.

### Heating Process

Thereafter, the layer 1 is heated (heating process). The reaction between the hydroxyl group of the binding resin 12 and the isocyanate group of the ultraviolet curable resin can be accelerated by heating the layer 1. As a result, binding strength between the particles 11 can be made particularly excellent, and thus the mechanical strength of the three-dimensional structure 100 to be finally obtained can be made particularly excellent.

The heating temperature in the heating process is preferably 40° C. to 100° C., and more preferably 50° C. to 80° C. Thus, the reaction between the hydroxyl group of the binding resin 12 and the isocyanate group of the ultraviolet curable resin can more efficiently proceed.

Thereafter, a series of the processes are repeated (refer to 1D, 2A, and 2B). Thus, in each of the layers 1, the particles 11 are bound on the site on which the curable ink 2 has been applied, and, in this state, a three-dimensional structure 100 is obtained as a laminate in which the plurality of layers 1 are laminated (refer to 2C).

In the second and subsequent ink discharge processes (refer to 1D), the curable ink 2 applied to the layer 1 is used in binding the particles 11 constituting this layer 1, and a part of the applied curable ink 2 penetrates into the layer 1 located under this layer 1. For this reason, the curable ink 2 is used in binding the particles 11 between adjacent layers as well as binding the particles 11 in each of the layers 1. As a result, the three-dimensional structure 100 finally obtained becomes excellent in mechanical strength as a whole.

### Unbound Particle Removal Process

After the aforementioned series of processes are repeated, in the particles 11 constituting each of the layers 1, a process (2D) of removing the particles (unbound particles) not bound by the ultraviolet curable resin 21 is performed. Thus, a three-dimensional structure 100 is taken out.

Examples of specific methods used in this process include a method of dispelling unbound particles with a brush or the like, a method of removing unbound particles by suction, a method of blowing a gas such as air, a method of imparting a liquid such as water (for example, a method of dipping the laminate obtained as described above into liquid, a method of spraying liquid, or the like), and a method of imparting vibration such as ultrasonic vibration. These methods can be used in a combination of two or more thereof. More specifically, a method of blowing a gas such as air and then imparting a liquid such as water and a method of imparting vibration such as ultrasonic vibration with a laminate dipped into liquid such as water are exemplified. Among them, a method of imparting a liquid containing water to the laminate obtained in the manner described above (particularly, a method of dipping the laminate into the liquid containing water) is preferably employed. Thus, in the particles 11 constituting each of the layers 1, particles not bound by the ultraviolet curable resin are temporarily fixed by the binding resin 12. However, when the liquid containing water is used, the binding resin 12 is dissolved to release the temporary fixation, and thus these unbound particles can be more easily and reliably removed from the three-dimensional structure 100. In addition, it is possible to more reliably prevent the occurrence of defects such as scratches of the three-dimensional structure 100 at the time of removing the unbound particles. Moreover, by employing such a method, the cleaning of the three-dimensional structure 100 can also be performed together with the removing of the unbound particles.

In the aforementioned description, it has been described that the heating process is performed with respect to each layer 1, but is not limited thereto. For example, heat treatment may be performed after a plurality of layers are formed, may be performed after all the layers 1 are laminated, or may be performed after the unbound particle removal process.

### 2. Three-Dimensional Formation Composition

Next, the three dimension composition 1′ will be described in detail.

The three-dimensional formation composition 1′ contains a plurality of particles 11 and a binding resin 12.

Hereinafter, each component will be described in detail.

### Particle 11

The particle 11 has surface-hydrophilicity.

The surface-hydrophilicity of the particle 11 may be imparted by allowing the constituent material of the particle 11 to exhibit hydrophilicity, or may be imparted by surface treatment.

As the constituent material of the particle 11, for example, inorganic materials, organic materials, and complexes thereof are exemplified.

As the inorganic material constituting the particle 11, for example, various metals and metal compounds are exemplified. Examples of the metal compounds include: various metal oxides, such as silica, alumina, titanium oxide, zinc oxide, zirconium oxide, tin oxide, magnesium oxide, and potassium titanate; various metal hydroxides, such as magnesium hydroxide, aluminum hydroxide, and calcium hydroxide; various metal nitrides, such as silicon nitride, titanium nitride, and aluminum nitride; various metal carbides, such as silicon carbide and titanium carbide; various metal sulfides, such as zinc sulfide; various metal carbonates, such as calcium carbonate and magnesium carbonate; various metal sulfates, such as calcium sulfate and magnesium sulfate; various metal silicates, such as calcium silicate and magnesium silicate; various metal phosphates, such as calcium phosphate; various metal borates, such as aluminum borate and magnesium borate; and complexes thereof.

As the organic material constituting the particle 11, synthetic resins and natural polymers are exemplified. Specific examples of the organic material include polyethylene resins; polypropylene; polyethylene oxide; polypropylene oxide; polyethylene imine; polystyrene; polyurethane; polyurea; polyester; silicone resins; acrylic silicone resins; a polymer containing (meth)acrylic ester as a constituent monomer, such as polymethyl methacrylate; a crosspolymer (ethylene-acrylic acid copolymer resin or the like) containing (meth)acrylic ester as a constituent monomer, such as methyl methacrylate crosspolymer; polyamide resins, such as nylon 12, nylon 6 and copolymerized nylon; polyimide; carboxymethyl cellulose; gelatin; starch; chitin; and chitosan.

Among them, the particle 11 is preferably made of an inorganic material, more preferably made of a metal oxide, and further preferably made of silica. Thus, it is possible to make the characteristics, such as mechanical strength and light resistance, of the three-dimensional structure particularly excellent. Further, since silica is excellent even in fluidity, it is advantageous to form a layer higher thickness uniformity, and it is possible to make the productivity and dimensional accuracy of the three-dimensional structure 100 particularly excellent. Moreover, when the particle 11 is made of silica, it is possible to more effectively prevent the scattering of light caused by the particle 11 in the surface of the three-dimensional structure to be manufactured.

As silica, commercially available products can be suitably used. Specific examples thereof include Mizukasil P-526, Mizukasil P-801, Mizukasil NP-8, Mizukasil P-802, Mizukasil P-802Y, Mizukasil C-212, Mizukasil P-73, Mizukasil P-78A, Mizukasil P-78F, Mizukasil P-87, Mizukasil P-705, Mizukasil P-707, Mizukasil P-707D, Mizukasil P-709, and Mizukasil C-402, Mizukasil C-484 (all are manufactured by Mizusawa Industrial Chemicals, Ltd.); Tokusil U, Tokusil UR, Tokusil GU, Tokusil AL-1, Tokusil GU-N, Tokusil N, Tokusil NR, Tokusil PR, Solex, Finesil E-50, Finesil T-32, Finesil X-30, Finesil X-37, Finesil X-37B, Finesil X-45, Finesil X-60, Finesil X-70, Finesil RX-70, Finesil A, and Finesil B (all are manufactured by Tokuyama Corporation); SIPERNAT, CARPLEX FPS-101, CARPLEX CS-7, CARPLEX 22S, CARPLEX 80, CARPLEX 80D, CARPLEX XR, and CARPLEX 67 (all are manufactured by DSL. Japan Co., Ltd.); Syloid 63, Syloid 65, Syloid 66, Syloid 77, Syloid 74, Syloid 79, Syloid 404, Syloid 620, Syloid 800, Syloid 150, Syloid 244, and Syloid 266 (all are manufactured by Fuji Silysia Chemical Ltd.); Nipgel AY-200, Nipgel AY-6A2, Nipgel AZ-200, Nipgel AZ-6A0, Nipgel BY-200, Nipgel BY-200, Nipgel CX-200, Nipgel CY-200, Nipsil E-150J, Nipsil E-220A, and Nipsil E-200A (all are manufactured by Tosoh Silica Corporation).

The average particle diameter of the particle 11 is not particularly limited, but is preferably 1 μm to 25 μm, and more preferably 1 μm to 15 μm. Thus, it is possible to make the mechanical strength of the three-dimensional structure 100 particularly excellent, it is possible to more effectively prevent the occurrence of involuntary unevenness in the manufactured three-dimensional structure 100, and it is possible to make the dimensional accuracy of the three-dimensional structure 100 particularly excellent. Further, when the fluidity of three-dimensional formation powder or a three-dimensional formation composition containing the three-dimensional formation powder is made particularly excellent, it is possible to make the productivity of the three-dimensional structure 100 particularly excellent. In the invention, the average particle diameter refers to a volume average particle diameter, and can be obtained by measuring a dispersion liquid, which is prepared by adding a sample to methanol and dispersing the sample in methanol for 3 minutes using an ultrasonic disperser, using an aperture of 50 μm by a particle size distribution measuring instrument (TA-II, manufactured by Coulter Electronics Inc.) using a coulter counter method.

The Dₘₐₓ of the particle 11 is preferably 3 μm to 40 μm, and more preferably 5 μm to 30 μm. Thus, it is possible to make the mechanical strength of the three-dimensional structure 100 particularly excellent, it is possible to more effectively prevent the occurrence of involuntary unevenness in the manufactured three-dimensional structure 100, and it is possible to make the dimensional accuracy of the three-dimensional structure 100 particularly excellent. Further, when the fluidity of three-dimensional formation powder or a three-dimensional formation composition containing the three-dimensional formation powder is made particularly excellent, it is possible to make the productivity of the three-dimensional structure 100 particularly excellent. Moreover, it is possible to more effectively prevent the scattering of light caused by the particle 11 in the surface of the manufactured three-dimensional structure 100.

The particle 11 may have any shape, but, preferably, has a spherical shape. Thus, when the fluidity of three-dimensional formation powder or a three-dimensional formation composition containing the three-dimensional formation powder is made particularly excellent, it is possible to make the productivity of the three-dimensional structure 100 particularly excellent. Further, it is possible to more effectively prevent the occurrence of involuntary unevenness in the manufactured three-dimensional structure 100, and it is possible to make the dimensional accuracy of the three-dimensional structure 100 particularly excellent. Moreover, it is possible to more effectively prevent the scattering of light caused by the particle 11 in the surface of the manufactured three-dimensional structure 100.

The content ratio of three-dimensional formation powder in the three-dimensional formation composition 1′ is preferably 10 mass % to 90 mass %, and more preferably 15 mass % to 58 mass %. Thus, the fluidity of the three-dimensional formation composition 1′ can be made sufficiently excellent, and the mechanical strength of the three-dimensional structure 100 to be finally obtained can be made particularly excellent.

### Binding Resin

The three-dimensional formation composition 1′ contains a plurality of particles 11 and a binding resin 12. By allowing the three-dimensional formation composition 1′ to contain the binding resin 12, the particles 11 are bound (temporarily fixed) together to effectively prevent the involuntary scattering of the particles 11. Thus, it is possible to improve the safety of workers or the dimensional accuracy of the manufactured three-dimensional structure 100.

In the invention, the binding resin 12 has a hydroxyl group. Thus, the affinity to the surface of the particle 11 is improved, and thus the surface of the particle 11 can be easily coated. Further, the adhesiveness between the binding resin 12 and the surface of the particle 11 can be improved.

It is preferable that at least a part of the binding resin 12 is soluble in water. For example, the solubility (dissolvable mass in 100 g of water) of the binding resin 12 in water at 25° C. is preferably 5 [g/100 g water] or more, and further preferably 10 [g/100 g water] or more. Thus, the affinity to the surface of the particle 11 can be made higher, and, in the unbound particle removal process, unbound particles can be more easily removed.

Examples of the binding resin 12 include synthetic polymers, such as polyvinyl alcohol (PVA), polycaprolactone diol, polyethylene oxide, and a random copolymer of ethylene oxide and propylene oxide; natural polymers, such as cornstarch, mannan, pectin, agar, alginic acid, dextran, glue, and gelatin; and semi-synthetic polymers, such as carboxymethyl cellulose, hydroxyethyl cellulose, oxidized starch, and modified starch. They can be used alone or in a combination of two or more selected therefrom.

Specific examples of the binding resin product include methyl cellulose (Metolose SM-15, manufactured by Shin-Etsu Chemical Co., Ltd.), hydroxyethyl cellulose (AL-15, manufactured by Fuji Chemical Industries Ltd.), hydroxypropyl cellulose (HPC-M, manufactured by Nippon Soda Co., Ltd.,), carboxymethyl cellulose (CMC-30, manufactured by Nichirin Chemical Co.), starch sodium phosphate (I) (Hosuta 5100, manufactured by Matsutani Chemical Industry Co., Ltd.), polyethylene oxide (PEO-1, manufactured by Steel Chemical Co., Ltd.; Alcox, manufactured by Meisei Chemical Works, Ltd.), and a random copolymer of ethylene oxide and propylene oxide (Alcox EP, manufactured by Meisei Chemical Works, Ltd.).

Among them, as the binding resin 12, at least one selected from the group consisting of polyethylene glycol, polyethylene oxide, polyvinyl alcohol, carboxymethyl cellulose, and hydroxyethyl cellulose is preferably used. Thus, the mechanical strength of the three-dimensional structure 100 can be made particularly excellent. Polyvinyl alcohol can more suitably control the characteristics (for example, solubility in water, water resistance, and the like) of the binding resin 12 and the characteristics (for example, viscosity, fixing force of particles 11, wettability, and the like) of the three-dimensional formation composition 1′ by adjusting saponification degree and polymerization degree. Therefore, it is possible to appropriately cope with the manufacture of various three-dimensional structures 100. In addition, among various binding resins, polyvinyl alcohol is inexpensive, and supply thereof is stable. Therefore, it is possible to stably manufacture the three-dimensional structure 100 while suppressing the production cost thereof.

In the three-dimensional formation composition 1′, preferably, the binding resin 12, at least in the layer forming process, is present in a liquid state (for example, a dissolved state, a molten state, or the like). Thus, it is possible to easily and reliably make the thickness uniformity of the layer 1 formed using the three-dimensional formation composition 1′ higher.

The content ratio of the binding resin 12 in the three-dimensional formation composition 1′ is preferably 15 vol % or less, and more preferably 2 vol % to 5 vol %, based on the bulk volume of the particle 11. Thus, the aforementioned function of the binding resin 12 can be sufficiently exhibited, a space through which the curable ink 2 passes can be further widely secured, and the mechanical strength of the three-dimensional structure 100 can be made particularly excellent.

### Solvent

The three-dimensional formation composition 1′ may contain a solvent in addition to the aforementioned binding resin 12 and particle 11. Thus, the fluidity of the three-dimensional formation composition 1′ becomes particularly excellent, and thus, the productivity of the three-dimensional structure 100 can be particularly improved.

As the solvent, a solvent dissolving the binding resin 12 is preferable. Thus, the fluidity of the three-dimensional formation composition 1′ can become better, and thus it is possible to more effectively prevent the involuntary variation in the thickness of the layer 1 which is formed using the three-dimensional formation composition 1′. In addition, when the layer 1 is formed in a state in which the solvent was removed, it is possible to adhere the binding resin 12 to the particle 11 with higher uniformity over the entire layer 1, and thus it is possible to more effectively prevent involuntary composition unevenness from occurring. Therefore, it is possible to more effectively prevent the occurrence of involuntary variation in mechanical strength at each site of the finally obtained three-dimensional structure 100, and it is possible to further increase the reliability of the three-dimensional structure 100.

Examples of the solvent constituting the three-dimensional formation composition 1′ include water; alcoholic solvents, such as methanol, ethanol, and isopropanol; ketone-based solvents, such as methyl ethyl ketone and acetone; glycol ether-based solvents, such as ethylene glycol monoethyl ether and ethylene glycol monobutyl ether; glycol ether acetate-based solvents, such as propylene glycol 1-monomethyl ether 2-acetate and propylene glycol 1-monomethyl ether 2-acetate; polyethylene glycol; and polypropylene glycol. They can be used alone or in a combination of two or more selected therefrom.

Preferably, the three-dimensional formation composition 1′ contains water. Therefore, the binding resin 12 can be more reliably dissolved, and thus the fluidity of the three-dimensional formation composition 1′ or the composition uniformity of the layer 1 formed using the three-dimensional formation composition 1′ can be made particularly excellent. Further, water is easily removed after the formation of the layer 1, and does not negatively influence the three-dimensional formation composition 1′ even when it remains in the three-dimensional structure 100. Moreover, water is advantageous in terms of safety for human body and environmental issues.

When the three-dimensional formation composition 1′ contains a solvent, the content ratio of the solvent in the three-dimensional formation composition 1′ is preferably 5 mass % to 75 mass %, and more preferably 35 mass % to 70 mass %. Thus, the aforementioned effects due to the containing of the solvent can be more remarkably exhibited, and, in the process of manufacturing the three-dimensional structure 100, the solvent can be easily removed in a short time, and thus it is advantageous in terms of improvement in productivity of the three-dimensional structure 100.

In particular, when the three-dimensional formation composition 1′ contains water as the solvent, the content ratio of water in the three-dimensional formation composition 1′ is preferably 20 mass % to 73 mass %, and more preferably 50 mass % to 70 mass %. Thus, the aforementioned effects are more remarkably exhibited.

### Other Components

The three-dimensional formation composition 1′ may contain components other than the aforementioned components. Examples of these components include a polymerization initiator; a polymerization accelerator; a penetration enhancer; a wetting agent (humectant); a fixing agent; a fungicide; a preservative; an antioxidant; an ultraviolet absorber; a chelating agent; and a pH adjuster.

### 3. Curable Ink

Next, the ink used in manufacturing the three-dimensional structure of the invention will be described in detail.

### Ultraviolet Curable Resin

The curable ink 2 contains at least an ultraviolet curable resin 21 having an isocyanate group.

The ultraviolet curable resin 21 is a component having a function of binding the particles 11 together by curing with ultraviolet rays. In addition, the ultraviolet curable resin 21 has a function of more strongly binding the particles 11 together by forming a urethane bond between the ultraviolet curable resin 21 and the hydroxyl group of the binding resin.

Examples of the ultraviolet curable resin having an isocyanate group include 2-acryloyloxyethyl isocyanate, 2-methacryloyloxyethyl isocyanate, and 1,1-(bisacryloyloxymethyl)ethyl isocyanate.

Here, the curable ink 2 may contain a curable resin other than the ultraviolet curable resin having an isocyanate group.

Examples of the curable resin include thermosetting resin; various photocurable resins, such as a visible light curable resin (narrowly-defined phtocurable resin), an ultraviolet curable resin, and an infrared curable resin; and X-ray curable resins. They can be used alone or in a combination of two or more thereof.

The content ratio of the ultraviolet curable resin 21 in the curable ink 2 is preferably 80 mass % or more, and preferably 85% or more. Thus, it is possible to make the mechanical strength of the finally obtained three-dimensional structure 100 particularly excellent.

### Other Components

The curable ink 2 may contain other components in addition to the above-mentioned components. Examples of these components include various colorants such as pigment and dyes; dispersants; surfactants; polymerization initiators; polymerization accelerators; solvents; penetration enhancers; wetting agents (humectants); fixing agents; antifungal agents; preservatives; antioxidants; UV absorbers; chelating agents; pH adjusting agents; thickeners; fillers; aggregation inhibitors; and defoamers.

Particularly, when the curable ink 2 contains the colorant, it is possible to obtain a three-dimensional structure 100 colored by a color corresponding to the color of the colorant.

Particularly, when the curable ink 2 contains pigment as the colorant, it is possible to make the light resistance of the curable ink 2 or the three-dimensional structure 100 good. As the pigment, both inorganic pigments and organic pigments can be used.

Examples of inorganic pigments include carbon blacks (C.I. Pigment Black 7) such as furnace black, lamp black, acetylene black, and channel black; iron oxide; and titanium oxide. They can be used alone or in a combination of two or more selected therefrom.

Among these inorganic pigments, in order to exhibit preferred white color, titanium oxide is preferable.

Examples of organic pigments include azo pigments such as insoluble azo pigments, condensed azo pigments, azo lakes, and chelate azo pigments; polycyclic pigments such as phthalocyanine pigments, perylene and perinone pigments, anthraquinone pigments, quinacridone pigments, dioxane pigments, thioindigo pigments, isoindolinone pigments, quinophthalone pigments; dye chelates (for example, basic dye chelates, acidic dye chelates, and the like); staining lakes (basic dye lakes, acidic dye lakes); nitro pigments; nitroso pigments; aniline blacks; and daylight fluorescent pigments. They can be used alone or in a combination of two or more selected therefrom.

More specifically, examples of carbon black used as black pigment include No. 2300, No. 900, MCF88, No. 33, No. 40, No. 45, No. 52, MA7, MA8, MA100, and No. 2200B (all are manufactured by Mitsubishi Chemical Corporation); Raven 5750, Raven 5250, Raven 5000, Raven 3500, Raven 1255, and Raven 700 (all are manufactured by Carbon Columbia Co., Ltd.); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all are manufactured by CABOT JAPAN K.K.); and Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all are manufactured by Degussa Co., Ltd.).

Examples of white pigment include C.I. Pigment White 6, 18, and 21.

Examples of yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of red-violet (magenta) pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245; and C.I. Pigment Violet 19, 23, 32, 33, 36, 38, 43, and 50.

Examples of indigo-violet (cyan) pigment include C.I. Pigment Blue 1, 2, 3, 15, 15:1, 15:2, 15:3, 15:34, 15:4, 16, 18, 22, 25, 60, 65, and 66; and C.I. Bat Blue 4 and 60.

Examples of pigments other than the above pigments include C.I. Pigment Green 7 and 10; C.I. Pigment Brown 3, 5, 25, and 26; C.I. Pigment Orange 1, 2, 5, 7, 13, 14, 15, 16, 24, 34, 36, 38, 40, 43, and 63.

When the curable ink 2 contains a pigment, the average particle diameter of the pigment is preferably 300 nm or less, and more preferably 50 nm to 250 nm. Thus, the discharge stability of the curable ink 2 and the dispersion stability of the pigment in the curable ink 2 can be particularly excellent, and images with better image quality can be formed.

In the case where the curable ink 2 contains the pigment, when the average particle diameter of the particle 11 is expressed by d1 [nm] and the average particle diameter of the pigment is expressed by d2 [nm], preferably, the relationship of d1/d2>1 is satisfied, and, more preferably, the relationship of 1.1≦d1/d2≦6 is satisfied. When this relationship is satisfied, the pigment can be suitably retained in the holes of the particle 11. Therefore, the involuntary scattering of the pigment can be prevented, and thus it is possible to reliably form an image with high dimensional accuracy.

Examples of dyes include acid dyes, direct dyes, reactive dyes, and basic dyes. They can be used alone or in a combination of two or more thereof.

Specific examples of dyes include C.I. Acid Yellow 17, 23, 42, 44, 79, and 142; C.I. Acid Red 52, 80, 82, 249, 254, and 289; C.I. Acid Blue 9, 45, and 249; C.I. Acid Black 1, 2, 24, and 94; C.I. Food Black 1, and 2; C.I. Direct Yellow 1, 12, 24, 33, 50, 55, 58, 86, 132, 142, 144, and 173; C.I. Direct Red 1, 4, 9, 80, 81, 225, and 227; C.I. Direct Blue 1, 2, 15, 71, 86, 87, 98, 165, 199, and 202; C.I. Direct black 19, 38, 51, 71, 154, 168, 171, and 195; C.I. Reactive Red 14, 32, 55, 79, and 249; and C.I. Reactive Black 3, 4, and 35.

When the curable ink 2 contains a colorant, the content ratio of the colorant in the curable ink 2 is preferably 1 mass % to 20 mass %. Thus, particularly excellent hiding properties and color reproducibility are obtained.

Particularly, when the curable ink 2 contains titanium oxide as the colorant, the content ratio of titanium oxide in the curable ink 2 is preferably 12 mass % to 18 mass %, and more preferably 14 mass % to 16 mass %. Thus, particularly excellent hiding properties are obtained.

When the curable ink 2 contains a dispersant in addition to a pigment, the dispersibility of the pigment can be further improved. As a result, it is possible to more effectively suppress the partial reduction in mechanical strength due to the bias of the pigment.

The dispersant is not particularly limited, but examples thereof include dispersants, such as polymer dispersant, generally used in preparing a pigment dispersion liquid. Specific examples of the polymer dispersants include polymer dispersants containing one or more of polyoxyalkylene polyalkylene polyamine, vinyl polymers and copolymers, acrylic polymers and copolymers, polyesters, polyamides, polyimides, polyurethanes, amino-based polymers, silicon-containing polymers, sulfur-containing polymers, fluorinated polymers, and epoxy resins, as main component. Examples of commercially available products of polymer dispersants include AJISPER series of Ajinomoto Fine-techno Co., Inc.; Solspers series (Solsperse 36000 and the like) commercially available from Noveon Corporation; DISPERBYK series of BYK Japan K.K.; and DISPERBYK series of Kusumoto Chemicals, Ltd.

When the curable ink 2 contains a surfactant, the abrasion resistance of the three-dimensional structure 100 can be better. The surfactant is not particularly limited, but examples thereof include silicone-based surfactants such as polyester-modified silicone, and polyether-modified silicone. Among them, polyether-modified polydimethylsiloxane or polyester-modified polydimethylsiloxane is preferably used. Specific examples of the surfactant include BYK-347, BYK-348, BYK-UV3500, 3510, 3530, and 3570 (all are trade names of BYK Japan K.K.).

The curable ink 2 may contain a solvent. Thus, the viscosity of the curable ink 2 can be suitably adjusted, and the discharge stability of the curable ink 2 by an ink jet method can be particularly excellent even when it contains a component having high viscosity.

Examples of the solvent include (poly)alkylene glycol monoalkyl ethers such as ethylene glycol monomethyl ether, ethylene glycol monoethyl ether, propylene glycol monomethyl ether, and propylene glycol monoethyl ether; acetic acid esters, such as ethyl acetate, n-propyl acetate, iso-propyl acetate, n-butyl acetate, and iso-butyl acetate; aromatic hydrocarbons such as benzene, toluene, and xylene; ketones, such as methyl ethyl ketone, acetone, methyl isobutyl ketone, ethyl-n-butyl ketone, diisopropyl ketone, and acetylacetone; alcohols, such as ethanol, propanol, and butanol. They can be used alone or in a combination of two or more thereof.

The viscosity of the curable ink 2 is preferably 10 mPa·s to 25 mPa·s, and more preferably 15 mPa·s to 20 mPa·s. Thus, the discharge stability of ink by an ink jet method can be particularly excellent. In the present specification, viscosity refers to a value measured at 25° C. using an E-type viscometer (VISCONIC ELD, manufactured by Tokyo Keiki Inc.).

Meanwhile, in the manufacture of the three-dimensional structure 100, several kinds of curable ink 2 may be used.

For example, curable ink 2 (color ink) containing a colorant and curable ink 2 (clear ink) containing no colorant may be used. Thus, for example, for the appearance of the three-dimensional structure 100, the curable ink 2 containing a colorant may be used as a curable ink 2 applied to the region influencing color tone, and, for the appearance of the three-dimensional structure 100, the curable ink 2 containing no colorant may be used as a curable ink 2 applied to the region not influencing color tone. Further, in the three-dimensional structure 100 to be finally obtained, several kinds of curable inks 2 may be used in combination with each other such that the region (coating layer) formed using the curable ink 2 containing no colorant is provided on the outer surface of the region formed using the curable ink 2 containing a colorant.

For example, several kinds of curable inks 2 containing colorants having different compositions from each other may be used. Thus, a wider color reproducing area that can be expressed can be realized by the combination of these curable inks 2.

When the several kinds of curable inks 2 are used, it is preferable that at least indigo-violet (cyan) curable ink 2, red-violet (magenta) curable ink 2, and yellow curable ink 2 are used. Thus, a wider color reproducing area that can be expressed can be realized by the combination of these curable inks 2.

Further, for example, the following effects are obtained by the combination of white curable ink 2 and other colored curable ink 2. That is, the three-dimensional structure 100 to be finally obtained can have a first area on which white curable ink 2 is applied, and a second area which is overlapped with the first area and provided on the outside of the first area, and on which curable ink 2 having a color other than white color is applied. Thus, the first area on which white curable ink 2 is applied can exhibit hiding properties, and the color saturation of the three-dimensional structure 100 can be enhanced.

### 4. Three-Dimensional Structure

The three-dimensional structure of the invention can be manufactured using the above-mentioned method. Thus, it is possible to provide a three-dimensional structure manufactured with excellent mechanical strength.

Applications of the three-dimensional structure of the invention are not particularly limited, but examples thereof appreciated and exhibited objects such as dolls and figures; and medical instruments such as implants; and the like.

In addition, the three-dimensional structure of the invention may be applied to prototype, mass-produced products, made-to-order goods, and the like.

Although preferred embodiments of the invention have been described, the invention is not limited thereto.

More specifically, for example, it has been described in the aforementioned embodiment that, in addition to the layer forming process and the ink discharge process, the curing process is also repeated in conjunction with the layer forming process and the ink discharge process. However, the curing process may not be repeated. For example, the curing process may be carried out collectively after forming a laminate having a plurality of layers that are not cured.

In the method of manufacturing a three-dimensional structure according to the invention, if necessary, a pre-treatment process, an intermediate treatment process, or a post-treatment process may be carried out.

As an example of the pre-treatment process, a process of cleaning a support (stage) is exemplified.

As the intermediate treatment process, for example, when the three-dimensional formation composition contains a solvent component (dispersion medium) such as water, a process of removing the solvent component may be carried out between the layer forming process and the ink discharge process. Thus, the layer forming process can be more smoothly performed, and the involuntary variation in the thickness of the formed layer can be more effectively prevented. As a result, it is possible to manufacture a three-dimensional structure having higher dimensional accuracy in higher productivity.

Examples of the post-treatment process include a cleaning process, a shape adjusting process of performing deburring or the like, a coloring process, a process of forming a covering layer, and an ultraviolet curable resin curing completion process of performing light irradiation treatment or heat treatment for reliably curing a uncured ultraviolet curable resin.

Further, it has been described in the aforementioned embodiment that ink is applied to all of the layers. However, a layer on which ink is not applied may exist. For example, ink may not be applied to the layer formed directly on a support (stage), thus allowing this layer to function as a sacrificial layer.

Moreover, in the aforementioned embodiment, the case of performing the ink discharge process using an ink jet method has been mainly described. However, the ink discharge process may be performed using other methods (for example, other printing methods).

### EXAMPLES

Hereinafter, the invention will be described in more detail with reference to the following specific Examples, but the invention is not limited to these Examples. In the following description, particularly, it is assumed that treatment showing no temperature condition is performed at room temperature (25° C.). Further, in the case where a temperature condition is not shown even in various measurement conditions, it is assumed that the measured values are values measured at room temperature (25° C.)

### [1] Manufacture of Three-Dimensional Structure

### Example 1

### 1. Preparation of Three-Dimensional Formation Composition

First, powder composed of silica particles having a plurality of hydroxyl groups on the surface thereof (silica particles formed by precipitation) was prepared.

Next, 100 parts by mass of the powder, 325 parts by mass of water, and 50 parts by mass of polyethylene oxide (viscosity average molecular weight: 150,000 to 400,000) were mixed to obtain a three-dimensional formation composition.

### 2. Manufacture of Three-Dimensional Structure

The three-dimensional structure A having a shape shown in FIG. 4, that is, having a shape in which 4 mm (thickness)×150 mm (length), each of the regions provided at both ends indicated by hatching (upper and lower ends in FIG. 4) has a width of 20 mm and a length of 35 mm, and the region sandwiched between these region has a width of 10 mm and a length of 80 mm was manufactured using the obtained three-dimensional formation composition as follows. Further, the three-dimensional structure B having a shape shown in FIG. 5, that is, having a cubic shape of 4 mm (thickness)×10 mm (width)×80 mm (length) was also manufactured using the obtained three-dimensional formation composition as follows.

First, a three dimension forming apparatus was prepared, and a layer (thickness: 100 μm) was formed on the surface of a support (stage) using the three-dimensional formation composition by a squeegee method (layer forming process).

Next, the formed layer was left at room temperature for 1 minute, thereby removing water contained in the three-dimensional formation composition.

Next, curable ink was applied to the layer made of the three-dimensional formation composition in a predetermined pattern by an ink jet method (ink discharge process). As the curable ink, curable ink having the following composition and a viscosity of 22 mPa·s at 25° C. was used.

### Ultraviolet Curable Resin

2-acryloyloxyethyl isocyanate: 90.75 mass % Polymerization initiator

bis(2,4,6-trimethylbenzoyl)-phenylphosphine oxide: 5 mass %

2,4,6-trimethylbenzoyl-diphenylphosphine oxide: 4 mass % Fluorescent whitening agent (sensitizer)

1,4-bis-(benzoxazoyl-2-yl) naphthalene: 0.25 mass %

Next, the layer was irradiated with ultraviolet rays to cure the ultraviolet curable resin contained in the three-dimensional formation composition (curing process).

Thereafter, a series of processes of the layer forming process to the curing process were repeated such that a plurality of layers are laminated while changing the pattern of the applied ink depending on the shape of the three-dimensional structure to be manufactured.

Next, the entire laminate obtained was heated to 60° C. for 100 minutes (heating process).

Thereafter, the laminate obtained in this way was dipped into water, and ultrasonic vibration was applied thereto to remove the particles not bound by the ultraviolet curable resin (unbound particles) from the particles constituting each of the layers, thereby obtaining the three-dimensional structure A and the three-dimensional structure B two by two, respectively.

Thereafter, a drying process was carried out at 60° C. for 20 minutes.

### Examples 2 to 5

Three-dimensional structures were respectively manufactured in the same manner as in Example 1, except that the configuration of each of the three-dimensional formation composition was changed as shown in Table 1 by changing the kinds of raw materials used in preparing the three-dimensional formation composition and the composition ratio of each of the components.

### Comparative Example 1

A three-dimensional structure was manufactured in the same manner as in Example 1, except that polyvinyl pyrrolidone (weight average molecular weight: 50000) was used as the binding resin.

### Comparative Example 2

A three-dimensional structure was manufactured in the same manner as in Example 1, except that silica particles having surface hydrophobicity (trade name “Nipsil SS-40”, manufactured by Tosoh Silica Corporation) were used as the particles.

### Comparative Example 3

A three-dimensional structure was manufactured in the same manner as in Example 1, except that the following composition was used as the curable ink.

### Ultraviolet Curable Resin

2-(2-vinyloxyethoxyl)ethyl acrylate: 90.75 mass % Polymerization initiator

bis(2,4,6-trimethylbenzoyl)-phenylphosphine oxide: 5 mass %

2,4,6-trimethylbenzoyl-diphenylphosphine oxide: 4 mass % Fluorescent whitening agent (sensitizer)

1,4-bis-(benzoxazoyl-2-yl) naphthalene: 0.25 mass %

The configurations of the three-dimensional structures of Examples and Comparative Examples are summarized in Table 1. In Table 1, silica is expressed by “SiO₂”, polyethylene oxide is expressed by “PEO”, polyethylene glycol is expressed by “PEG”, polyvinyl alcohol is expressed by “PVA”, carboxylmethyl cellulose is expressed by “CMC”, hydroxyethyl cellulose is expressed by “HEC”, and polyvinyl pyrrolidone is expressed by “PVP”.

TABLE 1

| | Particle | | | | | | | |
|---|---|---|---|---|---|---|---|---|
| | | Presence or | Average | | Binding resin | | Solvent | |
| | | absence of | particle | Content | | Content | | Content |
| | | hydroxyl | diameter | ratio | | ratio | | ratio |
| | Composition | group | (μm) | (mass %) | Composition | (mass %) | Kind | (mass %) |
| Ex. 1 | SiO₂ | Presence | 2.6 | 21.0 | PEO | 11.0 | H₂O | 68.0 |
| Ex. 2 | SiO₂ | Presence | 2.6 | 12.0 | PEG | 13.0 | H₂O | 75.0 |
| Ex. 3 | SiO₂ | Presence | 2.6 | 16.0 | PVA | 16.0 | H₂O | 68.0 |
| Ex. 4 | SiO₂ | Presence | 2.6 | 17.0 | CMC | 13.0 | H₂O | 70.0 |
| Ex. 5 | SiO₂ | Presence | 2.6 | 19.0 | HEC | 13.0 | H₂O | 68.0 |
| Comp. | SiO₂ | Presence | 2.6 | 21.0 | PVP | 11.0 | H₂O | 68.0 |
| Ex. 1 | | | | | | | | |
| Comp. | SiO₂ | Absence | 2.6 | 21.0 | PEO | 11.0 | H₂O | 68.0 |
| Ex. 2 | | | | | | | | |
| Comp. | SiO₂ | Presence | 2.6 | 21.0 | PEO | 11.0 | H₂O | 68.0 |
| Ex. 3 | | | | | | | | |

### [3] Evaluation

### [3.1] Tensile Strength and Tensile Elastic Modulus

The tensile strength and tensile elastic modulus of each of the three-dimensional structures A of Examples and Comparative Examples were measured under the conditions of a tensile yield stress of 50 mm/min and a tensile elastic modulus of 1 mm/min based on JIS K 7161: 1994 (ISO 527: 1993). The tensile strength and tensile elastic modulus thereof were evaluated based on the following criteria. Tensile strength

A: tensile strength of 35 MPA or more

B: tensile strength of 30 MPA to less than 35 MPa

C: tensile strength of 20 MPA to less than 30 MPa

D: tensile strength of 10 MPA to less than 20 MPa

E: tensile strength of less than 10 Mpa Tensile elastic modulus

A: tensile elastic modulus of 1.5 GPa or more

B: tensile elastic modulus of 1.3 GPa to less than 1.5 GPa

C: tensile elastic modulus of 1.1 GPa to less than 1.3 GPa

D: tensile elastic modulus of 0.9 GPa to less than 1.1 GPa

E: tensile elastic modulus of less than 0.9 Gpa

### [3.2] Bending Strength and Bending Elastic Modulus

The bending strength and bending elastic modulus of each of the three-dimensional structures B of Examples and Comparative Examples were measured under the conditions of a distance between supporting points of 64 mm and a testing speed of 2 mm/min based on JIS K 7171: 1994 (ISO 178: 1993). The bending strength and bending elastic modulus thereof were evaluated based on the following criteria.

### Bending Strength

A: bending strength of 65 MPA or more

B: bending strength of 60 MPA to less than 65 MPa

C: bending strength of 45 MPA to less than 60 MPa

D: bending strength of 30 MPA to less than 45 MPa

E: bending strength of less than 30 Mpa

### Bending Elastic Modulus

A: bending elastic modulus of 2.4 GPa or more

B: bending elastic modulus of 2.3 GPa to less than 2.4 GPa

C: bending elastic modulus of 2.2 GPa to less than 2.3 GPa

D: bending elastic modulus of 2.1 GPa to less than 2.2 GPa

E: bending elastic modulus of less than 2.1 Gpa

These results are summarized in Table 2.

TABLE 2

| | | Tensile | | Bending |
|---|---|---|---|---|
| | Tensile | elastic | Bending | elastic |
| | strength | modulus | strength | modulus |
| Ex. 1 | A | A | A | A |
| Ex. 2 | A | A | A | A |
| Ex. 3 | A | A | A | A |
| Ex. 4 | A | A | A | A |
| Ex. 5 | A | A | A | A |
| Comp. Ex. 1 | D | D | D | D |
| Comp. Ex. 2 | E | E | E | E |
| Comp. Ex. 3 | D | D | D | D |

As apparent from Table 2, in the invention, three-dimensional structures having excellent mechanical strength were obtained. In contrast to this, in Comparative Examples, sufficient results were not obtained.

The entire disclosure of Japanese Patent Application No. 2014-089575, filed Apr. 23, 2014 is expressly incorporated by reference herein.

What is claimed is:

1. A method of manufacturing a three-dimensional structure, in which the three-dimensional structure is manufactured by laminating a layer, the method comprising:
forming the layer using a three-dimension formation composition containing a surface-hydrophilic particle and a binding resin having a hydroxyl group; and
discharging a curable ink containing a ultraviolet curable resin having an isocyanate group to the layer.

2. The method of manufacturing a three-dimensional structure according to claim 1, further comprising:
heating the layer after discharging the ink.

3. The method of manufacturing a three-dimensional structure according to claim 2,
wherein heating temperature in the heating of the layer is 40° C. to 100° C.

4. The method of manufacturing a three-dimensional structure according to claim 1,
wherein the particle has a hydroxyl group on a surface thereof.

5. The method of manufacturing a three-dimensional structure according to claim 1,
wherein the particle is made of silica.

6. The method of manufacturing a three-dimensional structure according to claim 1,
wherein the binding resin is at least one selected from the group consisting of polyethylene glycol, polyethylene oxide, polyvinyl alcohol, carboxymethyl cellulose, and hydroxyethyl cellulose.

7. A three-dimensional structure, which is manufactured by the method of manufacturing a three-dimensional structure according to claim 1.

8. A three-dimensional structure, which is manufactured by the method of manufacturing a three-dimensional structure according to claim 2.

9. A three-dimensional structure, which is manufactured by the method of manufacturing a three-dimensional structure according to claim 3.

10. A three-dimensional structure, which is manufactured by the method of manufacturing a three-dimensional structure according to claim 4.

11. A three-dimensional structure, which is manufactured by the method of manufacturing a three-dimensional structure according to claim 5.

12. A three-dimensional structure, which is manufactured by the method of manufacturing a three-dimensional structure according to claim 6.
